(19) United States
(12) Patent Application Publication
(10) Pub. No.: US 2024/0198527 A1
(43) Pub. Date: Jun. 20, 2024

(54) PROGRAMMING DEVICE AND PROGRAM

(71) Applicant: FANUC CORPORATION, Yamanashi (JP)

(72) Inventor: Tatsuya OUMI, Yamanashi (JP)

(73) Assignee: FANUC CORPORATION, Yamanashi (JP)

(21) Appl. No.: 18/555,691

(22) PCT Filed: May 26, 2021
(86) PCT No.: PCT/JP2021/020083

§ 371 Date: Oct. 16, 2023

(51) Int. Cl. B25J 9/16; G05B 19/4155

(52) U.S. Cl. CPC B25J 9/1671; G05B 19/4155; G05B 2219/40354

(57) ABSTRACT

The present disclosure addresses the problem of providing a programming device and a program that can reduce an amount of correction required for a robot program created by off-line programming. The programming device of the present disclosure comprises a processing unit. The processing unit determines the entry of a virtual drive unit, which is obtained by simulating or emulating the drive unit of a robot by a computer, into a second singularity range wider than a first singularity range that is an actual singularity range of the drive unit.

### TECHNICAL FIELD

The present disclosure relates to a programming device and a program.

### BACKGROUND ART

A robot program causing a robot including a robot arm and other components to operate may be created through off-line programming. In off-line programming, programming is performed using a robot emulating or simulating an actual robot on software (hereinafter referred to as a “virtual robot”), for example. However, in programming using a virtual robot, various aspects, such as the positioning of an object, differ from those in an actual environment. Therefore, when a robot program created through off-line programming is corrected to fit an actual scene and an actual robot is operated, the robot program may attempt to operate the robot to outside its movable range or may operate the robot to its singularity. Thus, when causing an actual robot to operate under a robot program created through off-line programming, the program may need additional correction.
Patent Document 1: Japanese Unexamined Patent Application, Publication No. 2000-015593

### DISCLOSURE OF THE INVENTION

### Problems to be Solved by the Invention

It has been demanded a programming device and a program that make it possible to reduce an amount of correction required for a robot program created through off-line programming.

### Means for Solving the Problems

A programming device according to the present disclosure includes a processing unit. The processing unit determines that a virtual drive unit that is a computer simulation or emulation of a drive unit of a robot enters a second singularity range that is wider than a first singularity range representing an actual singularity range of the drive unit.

### Effects of the Invention

The present disclosure makes it possible to reduce an amount of correction required for a robot program created through off-line programming.

### BRIEF DESCRIPTION OF THE DRAWINGS

FIG. 1 is a block diagram illustrating an example of a main part configuration of a programming system according to an embodiment and components included in the programming system;

FIG. 2 is a diagram for explaining a drive unit illustrated in FIG. 1;

FIG. 3 is a flowchart illustrating an example of processing performed by a processor of a programming device illustrated in FIG. 1;

FIG. 4 is a flowchart illustrating an example of processing performed by the processor of the programming device illustrated in FIG. 1;

FIG. 5 is a view illustrating an example of a setting screen used to collectively set a virtual movable range of each of drive units;

FIG. 6 is a view illustrating an example of a setting screen used to individually set the virtual movable range of each of the drive units;

FIG. 7 is a view illustrating an example of a setting screen used to collectively set a singularity warning range of each of the drive units; and

FIG. 8 is a view illustrating an example of a setting screen used to individually set the singularity warning range of each of the drive units.

### PREFERRED MODE FOR CARRYING OUT THE INVENTION

A programming system according to an embodiment will now be described herein with reference to the accompanying drawings. Note that, in the drawings used to describe below the embodiment, there may be cases where the scale of each component is appropriately changed. Furthermore, in the drawings used to describe below the embodiment, some configurations may be omitted for the purpose of description. Furthermore, in the drawings and the specification, identical reference numerals represent similar or identical elements.

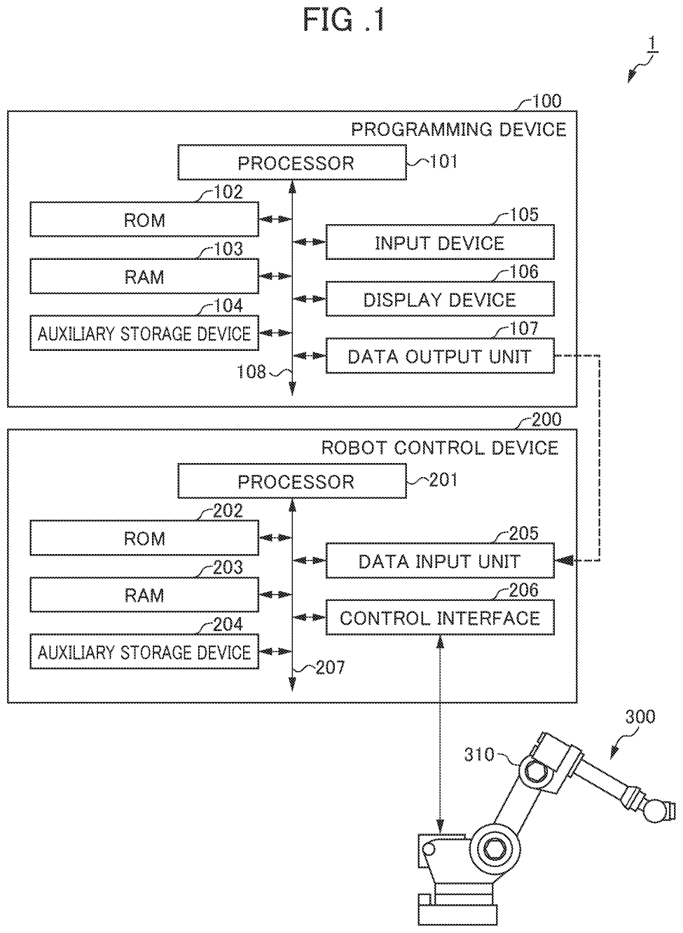

FIG. 1 is a block diagram illustrating an example of a main part configuration of a programming system 1 according to the embodiment and components included in the programming system 1. The programming system 1 is a system that makes it possible to create, through off-line programming, a robot program causing a robot 300 to operate. The programming system 1 includes, as an example, a programming device 100, a robot control device 200, and the robot 300.

The programming device 100 is a device that enables off-line programming for a robot program. Furthermore, the programming device 100 enables simulation or emulation of the robot 300 in a virtual space. The programming device 100 is, for example, a personal computer (PC), a server, a work station, or a tablet terminal. The programming device 100 includes, as an example, a processor 101, a read-only memory (ROM) 102, a random-access memory (RAM) 103, an auxiliary storage device 104, an input device 105, a display device 106, and a data output unit 107. Then, a bus 108 couples these components, for example.

The processor 101 serves as a central part of the computer that performs processing such as calculations and controls necessary for operating the programming device 100, and that performs various types of calculations and processing, for example. The processor 101 is, for example, a central processing unit (CPU), a micro processing unit (MPU), a system on a chip (SoC), a digital signal processor (DSP), a graphics processing unit (GPU), an application specific integrated circuit (ASIC), a programmable logic device (PLD), or a field-programmable gate array (FPGA). Otherwise, the processor 101 is a combination of a plurality of those described above. Furthermore, the processor 101 may be a combination of those described above and a hardware accelerator, for example. The processor 101 controls the components to achieve various types of functions of the programming device 100 based on programs, such as firmware, system software, and application software, stored in the ROM 102 or the auxiliary storage device 104, for example. Furthermore, the processor 101 executes processing described later based on the programs. Note that some or all of the programs may be incorporated into a circuit of the processor 101. The processor 101 represents an example of a processing unit.

The ROM 102 and the RAM 103 represent main storage devices for the computer that includes the processor 101 as the central part. The ROM 102 represents a non-volatile memory mainly used to read data. The ROM 102 stores the firmware, for example, among the programs described above. Furthermore, the ROM 102 further stores, for example, data that the processor 101 uses for performing various types of processing. The RAM 103 represents a memory used to read and write data. The RAM 103 is utilized, for example, as a work area for storing data that the processor 101 uses on a temporal basis for performing various types of processing. The RAM 103 typically represents a volatile memory.

The auxiliary storage device 104 represents an auxiliary storage device for the computer that includes the processor 101 as the central part. The auxiliary storage device 104 is, for example, an electric erasable programmable read-only memory (EEPROM), a hard disk drive (HDD), or a flash memory. The auxiliary storage device 104 stores, for example, the system software and the application software, among the programs described above. The auxiliary storage device 104 further stores, for example, data that the processor 101 uses for performing various types of processing, data such as a robot program generated through the processing in the processor 101, and various types of set values.

Furthermore, the auxiliary storage device 104 stores information each model of the robot 300 (hereinafter referred to as “model information”). The model information includes various types of information including, for example, a size and a shape each model and a movable range and a singularity range of each of the components. Furthermore, the model information includes setting information. The setting information includes various types of set values pertaining to each model, for example. The setting information includes, for example, settings of a virtual movable range and a singularity warning range described later.

The input device 105 receives an operation performed by an operator of the programming device 100. The input device 105 includes, for example, a keyboard, a keypad, a touch pad, a mouse, or a controller. Furthermore, the input device 105 may be a sound input device.

The display device 106 displays a screen for notifying various types of information to the operator of the programming device 100. The display device 106 is a display such as a liquid crystal display or an organic electro-luminescence (EL) display. Furthermore, it is possible to use a touch panel as the input device 105 and the display device 106. That is, it is possible to use a display panel that the touch panel includes as the display device 106 and a touch pad that the touch panel includes as the input device 105. Note that the display device 106 represents an example of a notification unit.

The data output unit 107 outputs data stored in the programming device 100. The data output unit 107 represents a device that writes data into a removable storage medium such as a semiconductor medium, an optical medium, or a magnetic medium. Otherwise, the data output unit 107 represents an interface coupled to other devices using communication cables such as universal serial bus (USB) cables or Ethernet (registered trademark) cables for establishing wired communications. Otherwise, the data output unit 107 represents an interface for establishing wireless communications with other devices.

The bus 108 includes, for example, a control bus, an address bus, and a data bus to transmit signals to be exchanged among the components of the programming device 100.

The robot control device 200 represents a device that controls the robot 300 based on a program such as a robot program. The robot control device 200 includes, as an example, a processor 201, a ROM 202, a RAM 203, an auxiliary storage device 204, a data input unit 205, and a control interface 206. Then, a bus 207 couples these components, for example.

The processor 201 serves as a central part of the computer that performs processing such as calculations and controls necessary for operating the robot control device 200, and that performs various types of calculations and processing, for example. The processor 201 is, for example, a CPU, an MPU, an SoC, a DSP, a GPU, an ASIC, a PLD, or an FPGA. Otherwise, the processor 201 is a combination of a plurality of those described above. Furthermore, the processor 201 may be a combination of those described above and a hardware accelerator, for example. The processor 201 controls the components to achieve various types of functions of the robot control device 200 based on programs, such as firmware, system software, application software, and a robot program, stored in the ROM 202 or the auxiliary storage device 204, for example. Furthermore, the processor 201 executes processing described later based on the programs. Note that some or all of the programs may be incorporated into a circuit of the processor 201.

The ROM 202 and the RAM 203 represent main storage devices for the computer that includes the processor 201 as the central part. The ROM 202 represents a non-volatile memory mainly used to read data. The ROM 202 stores the firmware, for example, among the programs described above. Furthermore, the ROM 202 further stores, for example, data that the processor 201 uses for performing various types of processing. The RAM 203 represents a memory used to read and write data. The RAM 203 is utilized, for example, as a work area for storing data that the processor 201 uses on a temporal basis for performing various types of processing. The RAM 203 typically represents a volatile memory.

The auxiliary storage device 204 represents an auxiliary storage device for the computer that includes the processor 201 as the central part. The auxiliary storage device 204 is, for example, an EEPROM, an HDD, or a flash memory. The auxiliary storage device 204 stores, for example, the system software, the application software, and the robot program, among the programs described above. Furthermore, the auxiliary storage device 204 further stores, for example, data that the processor 201 uses for performing various types of processing, data generated through the processing in the processor 201, and various types of set values.

The data input unit 205 receives an input such as data outputted by the data output unit 107 of the programming device 100. The data input unit 205 represents, for example, a device that reads data stored in a removable storage medium. Otherwise, the data input unit 205 represents an interface for establishing wired communications or wireless communications with the data output unit 107, for example.

The control interface 206 represents an interface used by the robot control device 200 to establish communications with the robot 300. The robot control device 200 controls the robot 300 via the control interface 206.

The bus 207 includes, for example, a control bus, an address bus, and a data bus to transmit signals to be exchanged among the components of the robot control device 200.

The robot 300 represents, for example, either a manipulator or a robot arm or a robot including the manipulator and the robot arm. The robot 300 represents, for example, an articulated robot. The robot 300 includes, as an example, one drive unit 310 or a plurality of drive units 310. Note that the robot 300 disposed in a virtual space represents an example of a virtual robot. The drive unit 310 used for the virtual robot is specifically referred to as a drive unit 310b. The drive unit 310b represents an example of a virtual drive unit.

The drive unit 310 represents a unit that is driven by a motor such as a servomotor. The drive unit 310 is driven and rotated around a drive shaft, for example.

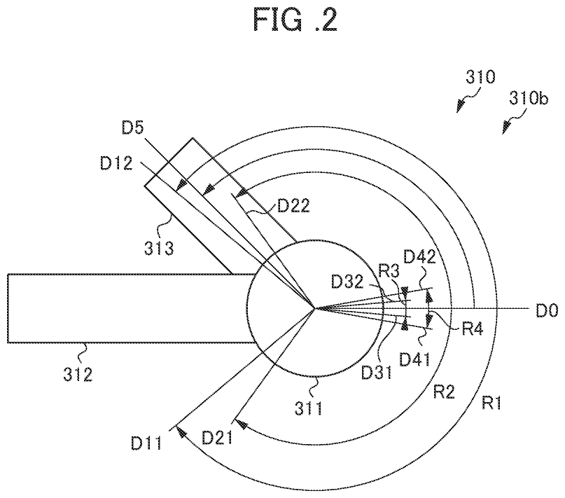

FIG. 2 is a diagram for explaining the drive unit 310 and the drive unit 310b. The drive unit 310 includes a drive shaft 311, a base-side arm 312, and a tip-side arm 313. Similarly, the drive unit 310b includes the drive shaft 311, the base-side arm 312, and the tip-side arm 313. Furthermore, FIG. 2 illustrates a movable range R1, a virtual movable range R2, a singularity range R3, and a singularity warning range R4. Note that the movable range R1 represents an example of a first movable range. The virtual movable range R2 represents an example of a second movable range. The singularity range R3 represents an example of a first singularity range. The singularity warning range R4 represents an example of a second singularity range.

The base-side arm 312 and the tip-side arm 313 are two arms coupled to each other via the drive shaft 311. The tip-side arm 313 represents an arm closer to a tip side of the robot arm 300 than the base-side arm 312, and an arm next closest to a base side of the robot arm 300 after the base-side arm 312. Note that the tip-side arm 313 may serve as the base-side arm 312 of another drive unit 310. The tip-side arm 313 is able to freely rotate within the movable range R1 around the drive shaft 311 relative to the base-side arm 312. The movable range R1 represents, as an example, a range extending from an angle D11[°] to an angle D12[°] inclusive, when a reference angle D0 is 0[° (degrees)]. Note that the angle D11 and the angle D12 are D11<0<D12. For example, the angle D11 and the angle D12 are D11=−D12.

In the programming device 100, the virtual movable range R2 is set for each of the drive units 310b. The virtual movable range R2 represents a range that is narrower than the movable range R1. The movable range R1 is a superset of the virtual movable range R2. The virtual movable range R2 represents, as an example, a range extending from an angle D21 [°] to an angle D22[°] inclusive, when the reference angle D0 is 0[°]. Note that the angle D21 and the angle D22 are D21<0<D22. For example, the angle D21 and the angle D22 are D21=−D22. A difference between the angle D11 and the angle D21 ranges from 0° to 10°, for example. A difference between the angle D12 and the angle D22 ranges from 0° to 10°, for example.

The singularity range R3 represents a range within which the tip-side arm 313 arrives at a singularity. Furthermore, in the programming device 100, the singularity warning range R4 is set for each of the drive units 310b. The singularity warning range R4 is a superset of the singularity range R3, and represents a range that is wider than the singularity range R3. The singularity range R3 represents, as an example, a range extending from an angle D31[°] to an angle D32[°] inclusive, when the reference angle D0 is 0[°]. Note that the angle D31 and the angle D32 are D31<0<D32. For example, the angle D31 and the angle D32 are D31=−D32. The singularity warning range R4 represents, as an example, a range extending from an angle D41[°] to an angle D42[°] inclusive, when the reference angle D0 is 0[°]. Note that the angle D41 and the angle D42 are D41<0<D42. For example, the angle D41 and the angle D42 are D41=−D42. A difference between the angle D41 and the angle D31 ranges from 0° to 6°, for example. A difference between the angle D42 and the angle D32 ranges from 0° to 6°, for example.

Furthermore, FIG. 2 illustrates an angle D5. The angle D5 represents an angle indicating a rotation position of the tip-side arm 313 relative to the base-side arm 312, when the reference angle D0 is 0[°]. D5 illustrated in FIG. 2 is, but not limited to, D22<D5<D12.

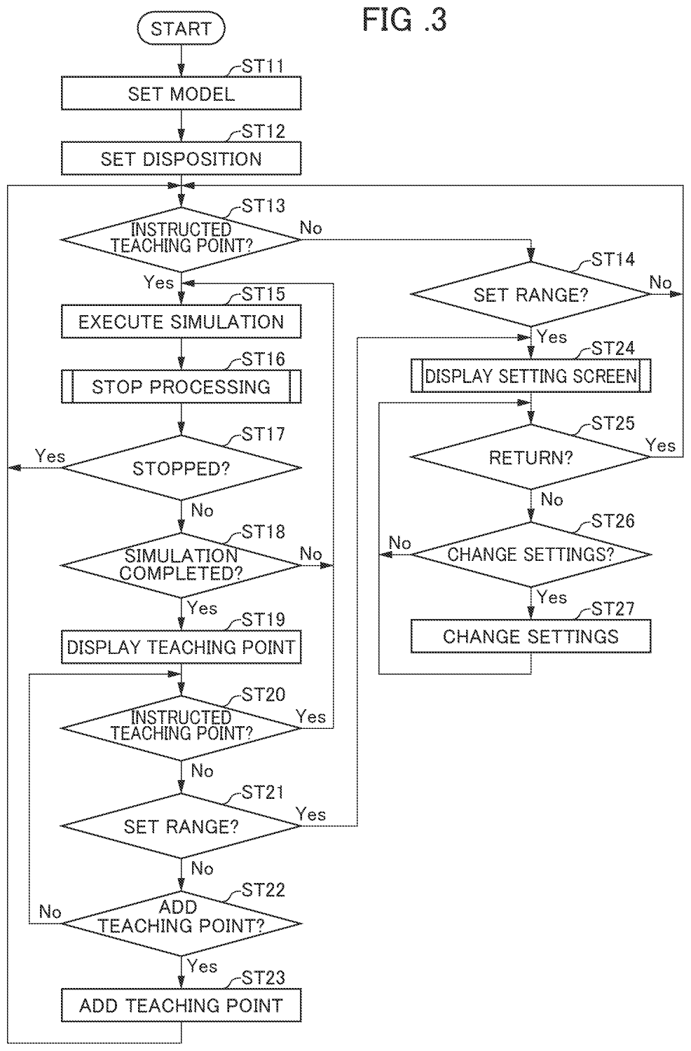

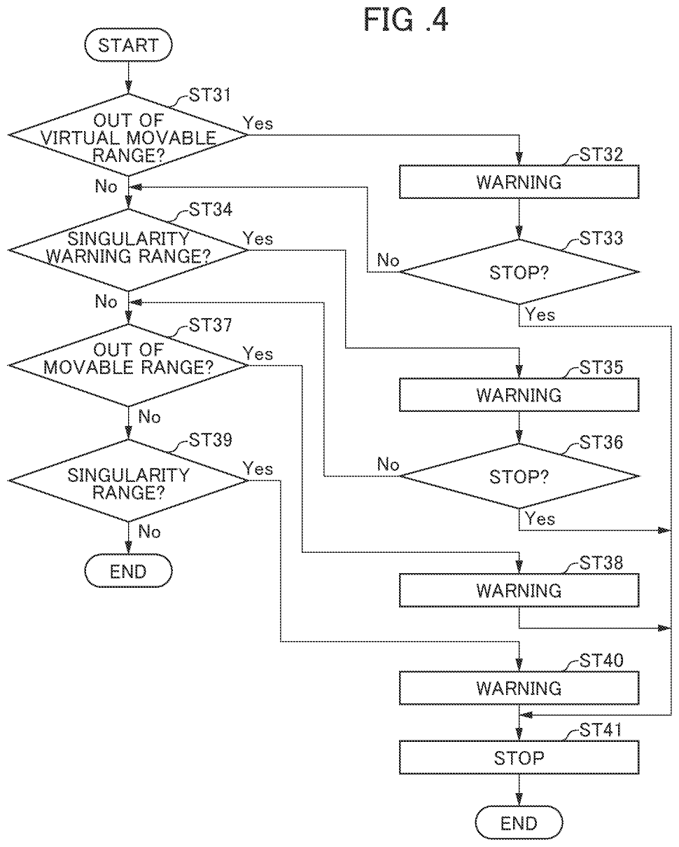

Operation of the programming system 1 according to the embodiment will now be described herein with reference to FIGS. 3 and 4, for example. Note that the content of the processing in the below operational description is a mere example. It is possible to appropriately utilize various types of processing that makes it possible to acquire similar results. FIGS. 3 and 4 are flowcharts illustrating examples of processing performed by the processor 101 of the programming device 100. The processor 101 executes the processing illustrated in FIGS. 3 and 4 based on the programs stored in the ROM 102 or the auxiliary storage device 104, for example.

For example, as application software for off-line programming starts, the processor 101 of the programming device 100 starts the processing illustrated in FIG. 3.

At Step ST11 in FIG. 3, the processor 101 determines settings for the model of the robot 300 representing a target for which a robot program is to be created, for example. The processor 101 acquires model information of the model of the robot 300 from the auxiliary storage device 104 for this purpose, for example. The model for which the processor 101 acquires model information is determined based on the content of an operational input using the input device 105 by the operator of the programming device 100, for example. Otherwise, the processor 101 may acquire model information of a predetermined model.

At Step ST12, the processor 101 determines settings for the placement of the robot 300, a workpiece, an obstruction, and other necessary objects in a virtual space. The processor 101 determines the settings for the placement based on the content of an operational input using the input device 105 by the operator of the programming device 100, for example. Furthermore, the processor 101 may determine the settings for the placement based on information acquired from the auxiliary storage device 104 or another device, for example.

At Step ST13, the processor 101 determines whether or not a teaching point indicating a destination for the robot 300 has been designated. For example, a teaching point is designated based on an operational input by the operator of the programming device 100. Otherwise, a teaching point is designated based on an input of information such as a command from another device. Otherwise, the processor 101 may automatically designate a teaching point. Furthermore, a teaching point may be designated using another method. Note that it is assumed in here that the teaching point designated at this time is referred to as a tentative teaching point. When no tentative teaching point is to be designated, the processor 101 determines No at Step ST13 and causes the processing to proceed to Step ST14.

At Step ST14, the processor 101 determines whether or not to start setting of a warning range. When an operation of starting setting of a warning range is performed by the operator of the programming device 100, for example, the processor 101 determines to start setting of a warning range. When setting of a warning range is not to be started, the processor 101 determines No at Step ST14 and causes the processing to return to Step ST13. Accordingly, until a tentative teaching point is designated or it is determined to start setting of a warning range, the processor 101 is in a stand-by state where Steps ST13 and ST14 are repeated.

When a teaching point indicating a destination for the robot 300 has been designated during the stand-by state for Steps ST13 and ST14, the processor 101 determines Yes at Step ST13 and causes the processing to proceed to Step ST15.

At Step ST15, the processor 101 advances, only by a predetermined amount, simulation of a moving path for the robot 300 in the virtual space from the latest teaching point to the tentative teaching point in the robot program under creation. The latest teaching point represents a teaching point that is finally added during the robot programming. When the simulation has been advanced to a certain point in the previous execution of Step ST15, the processor 101 advances the simulation from the certain point by a predetermined amount. Furthermore, when the simulation has not yet been started, the processor 101 starts and advances the simulation only by a predetermined amount. However, when the remaining part of the simulation until it is completed is smaller in amount than the predetermined amount, the processor 101 advances the simulation until the simulation is completed. In the simulation, the processor 101 advances the simulation to prevent all the drive units 310b from entering a range outside the virtual movable range R2 and from entering the singularity warning range R4. However, when it is impossible for the robot 300 to move to the tentative teaching point unless at least one of the drive units 310b enters a range outside the virtual movable range R2 or enters the singularity warning range R4, the processor 101 may simulate such a moving path that the one of the drive units 310b enters the range outside the virtual movable range R2 or enters the singularity warning range R4. Furthermore, even when at least one of the drive units 310b enters a range outside the virtual movable range R2 or enters the singularity warning range R4, the processor 101 performs simulation to prevent all the drive units 310b from entering a range outside the movable range R1 and from entering the singularity range R3. However, when the robot 300 is impossible to move to the tentative teaching point unless at least one of the drive units 310b enters a range outside the movable range R1 or enters the singularity range R3, the processor 101 may simulate such a moving path that the one of the drive units 310b enters the range outside the movable range R1 or enters the singularity range R3.

At Step ST16, the processor 101 executes stop processing illustrated in FIG. 4. Note that the processor 101 executes the stop processing for the most recent Step ST15, in the processing in the simulation being executed. The stop processing represents processing that determines whether or not to stop simulation based on a result at the most recent Step ST15 in the processing, stops the simulation when it determines to stop the simulation and others. As execution of the stop processing starts, the processor 101 causes the processing to proceed to Step ST31 in FIG. 4.

At Step ST31, the processor 101 determines whether or not at least one of the tip-side arms 313 of the robot 300 has newly exited the virtual movable range R2 due to the most recent Step ST15, in the processing in the simulation being executed. When the tip-side arm 313 has exited the virtual movable range R2, it is indicated that the angle D5 of the tip-side arm 313 is smaller than the angle D21 or is greater than the angle D22. Note that the processor 101 presumes, for the drive unit 310b with the virtual movable range R2 being inactive in the settings, that the tip-side arm 313 has not exited the virtual movable range R2 regardless of the angle D5. When at least one of the tip-side arms 313 has newly exited the virtual movable range R2, the processor 101 determines Yes at Step ST31 and causes the processing to proceed to Step ST32.

At Step ST32, the processor 101 generates an image corresponding to a first warning screen. Then, the processor 101 instructs the display device 106 to display the generated image. As the instruction for display is received, the display device 106 displays the first warning screen.

The first warning screen contains an image indicating that the tip-side arm 313 exits the virtual movable range R2. Furthermore, the first warning screen contains an image indicating which one of the tip-side arms 313 exits the virtual movable range R2. Note that one type of such an image is a character.

At Step ST33, the processor 101 determines whether or not to stop the simulation. For example, the processor 101 refers to the setting information and when the settings indicate that the simulation is to be stopped when the tip-side arm 313 has exited the virtual movable range R2, the processor 101 determines to stop the simulation.

When the it does not stop the simulation, the processor 101 determines No at Step ST33 and causes the processing to proceed to Step ST34. Furthermore, when none of the drive units 310b have newly exited the virtual movable range R2, the processor 101 determines No at Step ST31 and causes the processing to proceed to Step ST34.

At Step ST34, the processor 101 determines whether or not at least one of the tip-side arms 313 has newly entered the singularity warning range R4 at the most recent Step ST15, in the processing in the simulation being executed. When the tip-side arm 313 has entered the singularity warning range R4, it is indicated that the angle D5 of the tip-side arm 313 is equal to or greater than the angle D41 and smaller than the angle D42. Note that the processor 101 presumes, for the drive unit 310b with the singularity warning range R4 being inactive in the settings, that the tip-side arm 313 has not entered the singularity warning range R4 regardless of the angle D5. When at least one of the tip-side arms 313 has newly entered the singularity warning range R4, the processor 101 determines Yes at Step ST34 and causes the processing to proceed to Step ST35.

At Step ST35, the processor 101 generates an image corresponding to a second warning screen. Then, the processor 101 instructs the display device 106 to display the generated image. As the instruction for display is received, the display device 106 displays the second warning screen.

The second warning screen contains an image indicating that the tip-side arm 313 enters the singularity warning range R4. Furthermore, the second warning screen contains an image indicating which one of the tip-side arms 313 enters the singularity warning range R4.

At Step ST36, the processor 101 determines whether or not to stop the simulation. For example, the processor 101 refers to the setting information and when the settings indicate that the simulation is to be stopped when the tip-side arm 313 has entered the singularity warning range R4, the processor 101 determines to stop the simulation.

When the it does not stop the simulation, the processor 101 determines No at Step ST36 and causes the processing to proceed to Step ST37. Furthermore, when none of the tip-side arms 313 have newly entered the singularity warning range R4, the processor 101 determines No at Step ST34 and causes the processing to proceed to Step ST37.

At Step ST37, the processor 101 determines whether or not at least one of the tip-side arms 313 has newly exited the movable range R1 at the most recent Step ST15, in the processing in the simulation being executed. When at least one of the tip-side arms 313 has newly exited the movable range R1, the processor 101 determines Yes at Step ST37 and causes the processing to proceed to Step ST38.

At Step ST38, the processor 101 generates an image corresponding to a third warning screen. Then, the processor 101 instructs the display device 106 to display the generated image. As the instruction for display is received, the display device 106 displays the third warning screen.

The third warning screen contains an image indicating that the tip-side arm 313 exits the movable range R1. Furthermore, the third warning screen contains an image indicating which one of the tip-side arms 313 exits the movable range R1.

When none of the tip-side arms 313 have newly exited the movable range R1, the processor 101 determines No at Step ST37 and causes the processing to proceed to Step ST39. At Step ST39, the processor 101 determines whether or not at least one of the tip-side arms 313 has newly entered the singularity range R3 at the most recent Step ST15, in the processing in the simulation being executed. When none of the tip-side arms 313 have newly entered the singularity range R3, the processor 101 determines No at Step ST39 and ends the stop processing illustrated in FIG. 4. On the other hand, when at least one of the tip-side arms 313 has newly entered the singularity warning range R4, the processor 101 determines Yes at Step ST39 and causes the processing to proceed to Step ST40.

At Step ST40, the processor 101 generates an image corresponding to a fourth warning screen. Then, the processor 101 instructs the display device 106 to display the generated image. As the instruction for display is received, the display device 106 displays the fourth warning screen.

The fourth warning screen contains an image indicating that the tip-side arm 313 enters a singularity warning range R4. Furthermore, the fourth warning screen contains an image indicating which one of the tip-side arms 313 enters the singularity range R3.

When it is determined to stop the simulation at Step ST36, the processor 101 determines Yes and causes the processing to proceed to Step ST41. Furthermore, when it is determined to stop the simulation at Step ST33, the processor 101 determines Yes and causes the processing to proceed to Step ST41. Furthermore, after Step ST38 or Step ST41 in the processing, the processor 101 causes the processing to proceed to Step ST41.

At Step ST41, the processor 101 stops the simulation being executed. That is, the processor 101 stops the virtual robot being operated. The processor 101 causes a speaker to output sound such as an alarm indicating that the simulation has been stopped. Furthermore, the processor 101 may cause the display device 106 to display an image indicating that the simulation has been stopped. After Step ST41 in the processing, the processor 101 ends the stop processing illustrated in FIG. 4.

When the stop processing has been ended, the processor 101 ends Step ST16 in the processing in FIG. 3 and causes the processing to proceed to Step ST17.

At Step ST17, the processor 101 determines whether or not the simulation has been stopped at the most recent Step ST16, in the processing. When it has performed the simulation, the processor 101 determines Yes at Step ST17 and causes the processing to return to Step ST13. On the other hand, when the simulation has not been stopped, the processor 101 determines No at Step ST17 and causes the processing to proceed to Step ST18.

At Step ST18, the processor 101 determines whether or not the simulation of the moving path from the latest teaching point to the tentative teaching point has been completed. When the simulation has not yet been completed, the processor 101 determines No at Step ST18 and causes the processing to return to Step ST15. Then, the processor 101 executes the remaining part of the simulation at Step ST15. On the other hand, when the simulation has been completed, the processor 101 determines Yes at Step ST18 and causes the processing to proceed to Step ST20.

At Step ST19, the processor 101 generates an image corresponding to a teaching point screen. Then, the processor 101 instructs the display device 106 to display the generated image. As the instruction for display is received, the display device 106 displays the teaching point screen.

The teaching point screen represents a screen indicating that the simulation of the moving path from the latest teaching point to the tentative teaching point has been completed and indicating a result of the simulation. The teaching point screen contains an image indicating that it is possible to add a tentative teaching point to the robot program as a teaching point. The teaching point screen contains an image indicating the moving path from the latest teaching point to the tentative teaching point. Furthermore, the teaching point screen contains an image indicating that, when one of the tip-side arms 313 has exited the virtual movable range R2 in the simulation of the moving path from the latest teaching point to the tentative teaching point, the tip-side arm 313 exits the virtual movable range R2. Furthermore, the teaching point screen contains an image indicating that, when one of the tip-side arms 313 has entered the singularity warning range R4 in the simulation of the moving path from the latest teaching point to the tentative teaching point, the tip-side arm 313 enters the singularity warning range R4.

At Step ST20, the processor 101 determines whether or not a tentative teaching point indicating a destination for the robot 300 has been designated. That is, the processor 101 performs a step that is similar to Step ST13 in the processing. When no tentative teaching point is to be designated, the processor 101 determines No at Step ST20 and causes the processing to proceed to Step ST21.

At Step ST21, the processor 101 determines whether or not to start setting of a warning range. That is, the processor 101 performs a step that is similar to Step ST14 in the processing. When setting of a warning range is not to be started, the processor 101 determines No at Step ST21 and causes the processing to proceed to Step ST22.

At Step ST22, the processor 101 determines whether or not to add a tentative teaching point in the robot program under creation as a teaching point. The operator of the programming device 100 determines to add a teaching point by checking the content displayed on the teaching point screen, for example. Then, when a teaching point is to be added, the operator uses the input device 105 to perform an instruction operation to add a teaching point. As the operation is performed, for example, the processor 101 determines to add the teaching point. Furthermore, the processor 101 may automatically determine whether or not to add a teaching point based on a result of the simulation of the moving path from the latest teaching point to the tentative teaching point. For example, when none of the tip-side arms 313 have exited the virtual movable range R2 and have entered the singularity warning range R4 in the simulation, the processor 101 may determine to add a teaching point. When no teaching point is to be added, the processor 101 determines No at Step ST22 and causes the processing to return to Step ST20. Accordingly, until a teaching point indicating a destination for the robot 300 is designated, it is determined to start setting of a warning range, or it is determined to add a teaching point, the processor 101 stays in the stand-by state where Step ST20 to Step ST22 are repeated.

When a tentative teaching point has been designated during the stand-by state for Step ST20 to Step ST22, the processor 101 determines Yes at Step ST20 and causes the processing to return to Step ST15.

When a teaching point is to be added during the stand-by state for Step ST20 to Step ST22, the processor 101 determines Yes at Step ST22 and causes the processing to proceed to Step ST23. At Step ST23, the processor 101 adds the tentative teaching point in the robot program under creation as a teaching point. That is, based on a result of the simulation of the moving path for the robot 300 from the latest teaching point to the tentative teaching point, the processor 101 adds, in the robot program under creation, a program indicating the operation of the robot 300 for causing the robot 300 to move along the moving path from the latest teaching point to the tentative teaching point. Note that the tentative teaching point therefore becomes the latest teaching point at Step ST23 in the processing. After Step ST23 in the processing, the processor 101 causes the processing to return to Step ST13.

When it is determined to start setting of a warning range during the stand-by state for Step ST13 and Step ST14, the processor 101 determines Yes at Step ST14 and causes the processing to proceed to Step ST24. Furthermore, when it is determined to start setting of a warning range during the stand-by state for Step ST20 to Step ST22, the processor 101 determines Yes at Step ST21 and causes the processing to proceed to Step ST24.

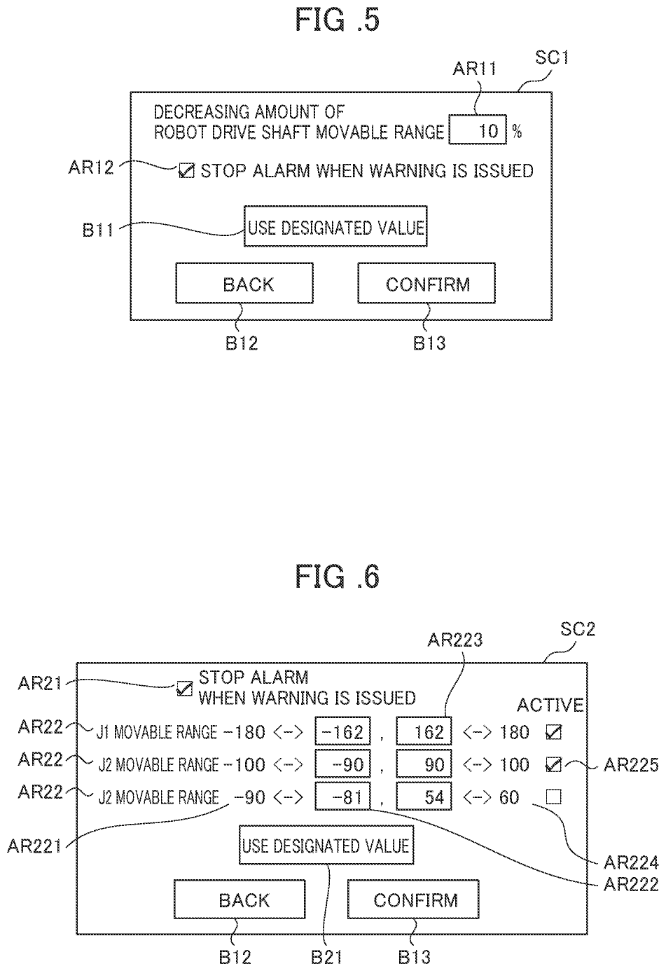

At Step ST24, the processor 101 generates an image corresponding to one of such setting screens as illustrated in FIGS. 5 to 8. Then, the processor 101 instructs the display device 106 to display the generated image. As the instruction for display is received, the display device 106 displays the setting screen.

FIGS. 5 to 8 respectively are views illustrating examples of the setting screens. For example, the processor 101 causes a setting screen to be displayed, which differs depending on what kind of a setting is to be performed. What kind of a setting is to be performed is determined based on the content of an operation by the operator of the programming device 100, for example.

FIG. 5 is a view illustrating an example of a setting screen SC1 used to collectively set the virtual movable range R2 of each of the drive units 310b. The setting screen SC1 includes a region AR11 and a region AR12 and further includes a default value button B11, a back button B12, and a confirm button B13. The region AR11 serves as an input field used to input a set value setting how much the virtual movable range R2 is to be a smaller range when compared with the movable range R1. In the region AR11 in FIG. 5, 10[%] is inputted as an example. In this case, when the movable range R1 extends from −140° to 140°, the virtual movable range R2 extends from −126° to 126°. That is, when the number inputted in the region AR12 is referred to as C1,

$$D 21 = D 11 \times ( 100 - C 1 ) \times 0.01 \qquad ( 1 )$$

$$D 22 = D 12 \times ( 100 - C 1 ) \times 0.01 \qquad ( 2 )$$

are satisfied. Otherwise,

$$D 21 = D 11 - ( D 12 - D 11 ) \times C 1 \times 0.01 \div 2 \qquad ( 3 )$$

$$D 22 = D 12 + ( D 12 - D 11 ) \times C 1 \times 0.01 \div 2 \qquad ( 4 )$$

may be satisfied.

The region AR11 may serve as an input field used to input an angle, instead of a percentage. When 10[°] is inputted in the region AR11, and the movable range R1 extends from −140° to 140°, as an example, the virtual movable range R2 extends from −130° to 130°. When the angle inputted in the region AR11 is referred to as C2,

$$D 21 = D 11 - C 2 \qquad ( 5 )$$

$$D 22 = D 12 - C 2 \qquad ( 6 )$$

are satisfied. Note that C2 represents a number that is greater than 0 and smaller than 100.

The region AR12 serves as a region used to input a setting of whether or not to stop simulation when one of the tip-side arms 313 has exited the virtual movable range R2. As an example, when a check box is in an on state, that is, the value in the region AR12 is True, for example, the region AR12 indicates a setting of stopping the simulation. Then, when the check box is in an off state, that is, the value in the region AR12 is False, for example, the region AR12 indicates a setting of not stopping the simulation.

The default value button B11 represents a button used to input default values in the region AR11 and the region AR12. When the default value button B11 is operated, the processor 101 inputs the predetermined default values in the region AR11 and the region AR12.

The back button B12 represents a button to be operated by the operator when the settings are not to be changed and the setting screen being displayed is to be ended.

The confirm button B13 represents a button to be operated by the operator when the content inputted in the setting screen is to be stored and the settings are to be changed.

FIG. 6 is a view illustrating an example of a setting screen SC2 used to individually set the virtual movable range R2 of each of the drive units 310b. The setting screen SC2 includes a region AR21 and a plurality of regions AR22 and further includes a default value button B21, the back button B12, and the confirm button B13. Each of the regions AR22 includes a region AR221 to a region AR225.

The region AR21 serves as a region used to input a setting of whether or not to stop simulation when one of the tip-side arms 313 has exited the virtual movable range R2. As an example, when a check box is in the on state, that is, the value in the region AR21 is True, for example, the region AR21 indicates a setting of stopping the simulation. Then, when the check box is in the off state, that is, the value in the region AR21 is False, for example, the region AR21 indicates a setting of not stopping the simulation.

The number of the regions AR22 being provided is identical to the number of the drive units 310b, for example. Then, each of the regions AR22 corresponds, in a one-by-one manner, to each of the drive units 310b that differ from each other. J1 to J3 illustrated in the regions AR22 respectively represent example numbers used to each identify which one of the drive units 310b corresponds to. The region AR221 displays the angle D11 of the corresponding one of the drive units 310b. The region AR222 serves as an input field used to input the angle D21 of the corresponding one of the drive units 310b. The region AR223 serves as an input field used to input the angle D22 of the corresponding one of the drive units 310b. The region AR224 displays the angle D12 of the corresponding one of the drive units 310b. The region AR225 serves as a region used to input a setting of whether or not to activate the virtual movable range R2 of the corresponding one of the drive units 310b. As an example, when the check box is in the on state, that is, the value in the region AR225 is True, for example, the region AR225 indicates that the virtual movable range R2 is activated. Then, when the check box is in the off state, that is, the value in the region AR225 is False, for example, the region AR225 indicates that the virtual movable range R2 is inactivated. Note that it may be possible to input a percentage to set the virtual movable range R2 in the setting screen SC2, similar to the setting screen SC1.

The default value button B21 represents a button used to input default values in the region AR21, the region AR222, the region AR223, and the region AR225. When the button B21 is operated, the processor 101 inputs the predetermined default values in the region AR21, the region AR222, the region AR223, and the region AR225. The default values are included in the model information, for example.

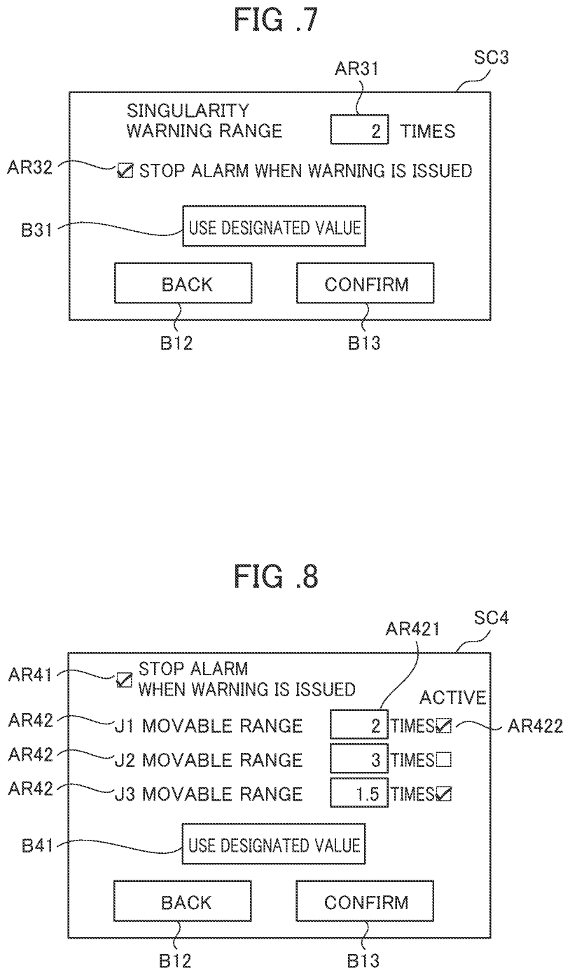

FIG. 7 is a view illustrating an example of a setting screen SC3 used to collectively set the singularity warning range R4 of each of the drive units 310b. The setting screen SC3 includes a region AR31 and a region AR32 and further includes a default value button B31, the back button B12, and the confirm button B13. The region AR31 serves as an input field used to input a set value setting how much the singularity warning range R4 is to be a greater range when compared with the singularity range R3. In the region AR31 in FIG. 7, 2 [times] is inputted, as an example. In this case, when the singularity range R3 extends from −5° to 5°, the virtual movable range R2 extends from −10° to 10°. That is, when the number inputted in the region AR32 is referred to as C3,

$$D 41 = D 31 \times C 3 \qquad ( 7 )$$

$$D 42 = D 32 \times C 3 \qquad ( 8 )$$

are satisfied. Otherwise,

$$D 41 = D 31 - ( D 32 - D 31 ) \times ( C 3 - 1 ) \qquad ( 9 )$$

$$D 42 = D 32 + ( D 32 - D 31 ) \times ( C 3 - 1 ) \qquad ( 10 )$$

may be satisfied. Note that C3 represents a number equal to or greater than 0. Note that it may be possible to input an angle in the region AR31. The angle indicates, for example, a difference between the angle D41 and the angle D31 and a difference between the angle D42 and the angle D32.

The region AR32 serves as a region used to input a setting of whether or not to stop the simulation when one of the tip-side arms 313 has entered the singularity range R3. As an example, when a check box is in the on state, that is, the value in the region AR32 is True, for example, the region AR32 indicates a setting of stopping the simulation. Then, when the check box is in the off state, that is, the value in the region AR32 is False, for example, the region AR32 indicates a setting of not stopping the simulation.

The default value button B31 represents a button used to input default values in the region AR31 and the region AR32. When the default value button B31 is operated, the processor 101 inputs the predetermined default values in the region AR31 and the region AR32. The default values are included in the model information, for example.

FIG. 8 is a view illustrating an example of a setting screen SC4 used to individually set the singularity warning range R4 of each of the drive units 310b. The setting screen SC4 includes a region AR41 and a plurality of regions AR42 and further includes a default value button B41, the back button B12, and the confirm button B13. Each of the regions AR42 includes a region AR421 and a region AR422.

The region AR41 serves as a region used to input a setting of whether or not to stop the simulation when one of the tip-side arms 313 has entered the singularity warning range R4. As an example, when a check box is in the on state, that is, the value in the region AR41 is True, for example, the region AR41 indicates a setting of stopping the simulation. Then, when the check box is in the off state, that is, the value in the region AR41 is False, for example, the region AR41 indicates a setting of not stopping the simulation.

The number of the regions AR42 being provided is identical to the number of the drive units 310b, for example. Then, each of the regions AR42 corresponds, in a one-by-one manner, to each of the drive units 310b that differ from each other. The region AR421 serves as an input field used to input a set value setting how much the singularity warning range R4 of the corresponding one of the drive units 310b is to be a greater range when compared with the singularity range R3. Note that it may be possible to input an angle in the region AR421. The region AR422 serves as a region used to input a setting of whether or not to activate the singularity warning range R4 of the corresponding one of the drive units 310b. As an example, when the check box is in the on state, that is, the value in the region AR422 is True, for example, the region AR422 indicates that the singularity warning range R4 is activated. Then, when the check box is in the off state, that is, the value in the region AR422 is False, for example, the region AR422 indicates that the singularity warning range R4 is inactivated.

The default value button B41 represents a button used to input default values in the region AR41, the region AR421, and the region AR422. When the default value button B31 is operated, the processor 101 inputs the predetermined default values in the region AR41, the region AR421, and the region AR422. The default values are included in the model information, for example.

The operator of the programming device 100 operates the setting screens as described above to input the content of desired settings.

At Step ST25, the processor 101 determines whether or not an instruction operation to return to the previous screen without changing the settings has been performed. That is, the processor 101 determines whether or not a predetermined operation has been operated, such as the back button B12 has been operated. When an instruction operation to return to the previous screen without changing the settings has not been performed, the processor 101 determines No at Step ST25 and causes the processing to proceed to Step ST26.

At Step ST26, the processor 101 determines whether or not an instruction operation to change the settings has been performed. That is, the processor 101 determines whether or not an operation determined beforehand has been operated, such as the confirm button B13 has been operated. When an instruction operation to change the settings has not been performed, the processor 101 determines No at Step ST26 and causes the processing to return to Step ST25. Accordingly, the processor 101 stays in the stand-by state where Step ST25 and Step ST26 are repeated until an instruction operation to return to the previous screen without changing the settings or an instruction operation to change the settings is performed.

When an instruction operation to return to the previous screen without changing the settings has been performed during the stand-by state for Step ST25 and Step ST26, the processor 101 determines Yes at Step ST25 and causes the processing to return to Step ST13. Furthermore, at this time, the processor 101 controls the display device 106 to end the setting screen being displayed.

When an instruction operation to change the settings has been performed during the stand-by state for Step ST25 and Step ST26, the processor 101 determines Yes at Step ST26 and causes the processing to proceed to Step ST27.

At Step ST27, the processor 101 causes the content of the settings based on the content inputted in the setting screen to be stored in the setting information stored in the auxiliary storage device 104, for example. After Step ST27 in the processing, the processor 101 causes the processing to return to Step ST25.

The programming device 100 according to the embodiment determines if the drive unit 310b of the virtual robot simulating or emulating the robot 300 enters the singularity warning range R4 wider than the actual singularity range R3. As described above, the programming device 100 according to the embodiment detects that the drive unit 310b enters the singularity warning range R4 and makes it possible to perform various types of processing, such as stopping the simulation and issuing a warning. Thereby, the programming device 100 according to the embodiment makes it possible to prevent the drive unit 310 of the actual robot 300 that is operating under a robot program created through off-line programming from entering the singularity range R3. Furthermore, thereby, the programming device 100 according to the embodiment makes it possible to reduce an amount of correction required for a robot program created through off-line programming.

Furthermore, the programming device 100 according to the embodiment notifies that the drive unit 310b of the virtual robot enters the singularity warning range R4. Thereby, the programming device 100 according to the embodiment makes it possible to prevent the drive unit 310 of the actual robot 300 operating under the robot program created through off-line programming from entering the singularity range R3 and to reduce an amount of correction required for the robot program.

Furthermore, the programming device 100 according to the embodiment stops the simulation when the drive unit 310b of the virtual robot enters the singularity warning range R4. That is, the programming device 100 stops the virtual robot being operated. This prevents the programming device 100 from adding to the robot program such a teaching point that would cause the drive unit 310b to enter the singularity warning range R4. Thereby, the programming device 100 according to the embodiment makes it possible to prevent the drive unit 310 of the actual robot 300 operating under the robot program created through off-line programming from entering the singularity range R3 and to reduce an amount of correction required for the robot program.

Furthermore, the programming device 100 according to the embodiment makes it possible to set how wide the singularity warning range R4 is. Thereby, it is conceivable that, as an authorized person such as a programmer of a robot program and an administrator of the programming system 1 changes the settings, for example, it is possible to easily perform off-line programming and to control the quality of a robot programming to be created through off-line programming.

Furthermore, the programming device 100 according to the embodiment determines that the drive unit 310b of the virtual robot exits the virtual movable range R2, which is narrower than the actual movable range R1. As described above, the programming device 100 according to the embodiment detects that the drive unit 310b exits the virtual movable range R2 and makes it possible to perform various types of processing, such as stopping the simulation and issuing a warning. Thereby, the programming device 100 according to the embodiment makes it possible to prevent the drive unit 310 of the actual robot 300 operating under the robot program created through off-line programming from entering the movable range R1. Furthermore, thereby, the programming device 100 according to the embodiment makes it possible to reduce an amount of correction required for a robot program created through off-line programming.

Furthermore, the programming device 100 according to the embodiment notifies that the drive unit 310b of the virtual robot exits the virtual movable range R2. Thereby, the programming device 100 according to the embodiment makes it possible to prevent the drive unit 310 of the actual robot 300 operating under the robot program created through off-line programming from exiting the movable range R1 and to reduce an amount of correction required for the robot program.

Furthermore, the programming device 100 according to the embodiment stops the simulation when the drive unit 310b of the virtual robot exits the virtual movable range R2. That is, the programming device 100 stops the virtual robot being operated. This prevents the programming device 100 from adding to the robot program such a teaching point that would cause the drive unit 310b to exits the virtual movable range R2. Thereby, the programming device 100 according to the embodiment makes it possible to prevent the drive unit 310 of the actual robot 300 operating under the robot program created through off-line programming from exiting the movable range R1 and to reduce an amount of correction required for the robot program.

Furthermore, the programming device 100 according to the embodiment makes it possible to set how wide the virtual movable range R2 is. Thereby, it is conceivable that, as an authorized person such as a programmer of a robot program and an administrator of the programming system 1 changes the settings, for example, it is possible to easily perform off-line programming and to control the quality of a robot programming to be created through off-line programming.

It is possible to modify the embodiment described above as described below. The programming device 100 may use another method to notify the content to be notified by displaying it on the display device 106 in the embodiment described above, such as causing a speaker to output sound. The speaker represents an example of a notification unit.

The unit of angle also used in the embodiment described above is [°]. However, the unit of angle used in the embodiment may be another unit such as [rad]. Furthermore, there is no limitation in the unit of angle used in the embodiment.

The unit of percentage used in the embodiment described above is [%] or [times]. However, there is no limitation in the unit of percentage used in the embodiment.

The processor 101 may be one where a part or a whole of the processing achieved by the programs in the embodiment described above is achieved by a circuit hardware configuration.

The programs that achieve the processing according to the embodiment are transferred in a state where the programs are stored in a device, for example. However, the device may be transferred in a state where the programs are not stored. The programs may then be separately transferred, and written into the device. It is possible to achieve the transferring of the programs at this time in such a manner that the programs are recorded in a removable storage medium, or otherwise the programs are downloaded via a network such as the Internet or a local area network (LAN), for example.

Although the embodiment of the present disclosure has been described, the illustrated embodiment is a mere example and is not intended to limit the scope of the present disclosure. It is possible to implement the embodiment of the present disclosure in various aspects without departing from the gist of the present disclosure.

### EXPLANATION OF REFERENCE NUMERALS

1 Programming system
100 Programming device
101, 201 Processor
102, 202 ROM
103, 203 RAM
104, 204 Auxiliary storage device
105 Input device
106 Display device (notification unit)
107 Data output unit
108, 207 Bus
200 Robot control device
205 Data input unit
206 Control interface
300 Robot
310 Drive unit
310b Drive unit (virtual drive unit)
311 Drive shaft
312 Base-side arm
313 Tip-side arm
R1 Movable range (first movable range)
R2 Virtual movable range (second movable range)
R3 Singularity range (first singularity range)
R4 Singularity warning range (second singularity range)

1. A programming device comprising a processing unit that determines that a virtual drive unit that is a computer simulation or emulation of a drive unit of a robot enters a second singularity range that is wider than a first singularity range representing an actual singularity range of the drive unit.

2. The programming device according to claim 1, wherein the processing unit controls, when it is determined that the virtual drive unit enters the second singularity range, a notification unit to notify that the virtual drive unit enters the second singularity range.

3. The programming device according to claim 1, wherein the processing unit stops, when it is determined that the virtual drive unit enters the second singularity range, the virtual drive unit from operating.

4. The programming device according to claim 1, wherein the processing unit sets the second singularity range based on an instruction input to change settings for the second singularity range.

5. The programming device according to claim 1, wherein the processing unit determines that the virtual drive unit exits a second movable range that is narrower than a first movable range representing an actual movable range of the drive unit.

6. The programming device according to claim 5, wherein the processing unit controls, when it is determined that the virtual drive unit exits the second movable range, a notification unit to notify that the virtual drive unit exits the second movable range.

7. The programming device according to claim 5, wherein the processing unit stops, when it is determined that the virtual drive unit exits the second movable range, the virtual drive unit from operating.

8. The programming device according to claim 5, wherein the processing unit sets the second movable range based on an instruction input to change settings for the second movable range.

9. A non-transitory computer readable medium storing a program causing a processor of a programming device
to function as a processing unit that determines that a virtual drive unit that is a computer simulation or emulation of a drive unit enters a second singularity range that is wider than a first singularity range representing an actual singularity range of the drive unit.
